(19) United States
(12) Patent Application Publication
(10) Pub. No.: US 2007/0126260 A1
(43) Pub. Date: Jun. 7, 2007

(54) Vehicle door opening system

(76) Inventors: Mattias Geyrhofer, Worrstadt (DE); Patrick Verhee, Koln (DE); Alex Daniel, Goteborg (SE)

Correspondence Address: HARNESS, DICKEY & PIERCE, P.L.C., P.O. BOX 8910, RESTON, VA, 20195, US

(21) Appl. No.: 11/485,529

(22) Filed: Jul. 13, 2006

(30) Foreign Application Priority Data
Jul. 18, 2005 (EP) 05106565.4

(51) Int. Cl. B60J 5/00

(52) U.S. Cl. 296/146.12; 296/146.11

(57) ABSTRACT

A wheeled automotive vehicle is disclosed including a vehicle body structure, including a driver compartment and including an opening into the compartment, and a central body cooperatively dimensioned and configured to close the opening, the opening being formed by portions of the body structure. The central body includes a side panel articulately arranged to portions of the central body by the opening along a lengthwise propagation of said vehicle body structure. The central body is pivotally arranged relative to an axis propagating in the transverse direction of the vehicle body structure for enabling pivotal movement upwards and away from the opening during opening movement. Furthermore, a method is disclosed for handling opening and closing of such door opening system.

### PRIORITY STATEMENT

The present application hereby claims priority under 35 U.S.C. §119 on European patent application number EPC 05106565.4 filed Jul. 18, 2005, the entire contents of which is hereby incorporated herein by reference.

### FIELD

The invention generally relates to a wheeled automotive vehicle. For example, it may relate to one including a vehicle body structure, including a driver compartment and including an opening into the compartment, and a central body cooperatively dimensioned and configured to close the opening, the opening being formed by portions of the body structure.

### TECHNICAL BACKGROUND

Crowded urban environment provides a need for more efficient use of parking spaces. Non-conventional door closures for wheeled automotive vehicles have been experimented with for many years, showing up in speciality cars and prototypes.

With conventional doors that swing out from the vehicle around a substantially vertical axis the length of the door must be minimized to reduce its outward trajectory when opened. In addition to making egress and access to the front seat a bit more complicated since the opening into the wheeled automotive vehicle is reduced these types of doors also requires that one enter from one direction, normally from the rear of the vehicle. Everyone, familiar with conventional automotive vehicles is well aware of the issue with swinging in and out doors in order to pass an open door and enter from the intended direction (i.e. from the rear).

A further issue with doors of conventional type is the potential hazard when the door is dangerously swinged out into, motor, bicycle or pedestrian traffic during a stop by a side of the road or street.

U.S. Pat. No. 6,676,193 B1 of Hanagan shows a compact vehicle with an upwardly opening side door. However, it is realized that the degree of opening during normal operation is low, making it difficult for people to access and egress. It is anticipated that there is a need for improvement of automobile doors for wheeled vehicles, such as for sedans, vans, trucks and other automobiles, and the issues of easy access as well as safe and comfortable opening needs to be further addressed.

U.S. Pat. No. 2,921,812 of Barenyi discloses a vehicle having a central section consisting of side wall sections, an upper bridge section and a “hood”, confining the passengers space at the top. The central section is a rigid structure. Moreover, the body of the car comprises a front section enclosing the front wheels, a rear section enclosing the rear wheels and wherein the front and rear sections are joined by a girder and floor section and adapted to fit the central section in between. According to one embodiment the central section, forming a “cap”, is hinged to the rear edge of the front section. The opening degree at the sides is similar to that of U.S. Pat. No. 6,676,193 B1 previously discussed. In order to increase the opening degree by the sides, with the purpose of facilitating access and egress of the vehicle, Barenyi discloses a second embodiment in which the “cap” is hinged at the front edge of said front section by lateral bars. The lateral bars extending lengthwise of the body at the outside thereof, such bars being pivotally connected to said front section. However, it may not be desirable to have lateral bars provided on the outside of the vehicle body and the issue of tolerances when fitting the rigid structure of the central section in a closed condition remains.

### SUMMARY

In at least one embodiment, to provide for a comfortable access and egress of a vehicle, a vehicle door opening system is provided that enables an accurate opening degree and capable of meeting the issue of tolerances.

In at least one embodiment, a vehicle is provided that requires a reduced or even a minimal amount of space beside the entry door for passenger access or egress.

In at least one embodiment, a vehicle door opening system is provided which is configured to handle tolerances.

According to at least one embodiment of the invention, there is provided a wheeled automotive vehicle having, a vehicle body structure including a driver compartment including an opening into the compartment, and a central body cooperatively dimensioned and configured to close the opening, the opening being formed by portions of the body structure. The central body includes a side panel articulately arranged to portions of the central body by the opening along a lengthwise propagation of the vehicle body structure, and the central body is pivotally arranged relative to an axis propagating in the transverse direction of the vehicle body structure to enable pivotal movement upwards and away from the opening during opening movement.

By combining these two moves an increased opening degree is accomplished together with a high flexibility, allowing for adjustments of the position of the central body thus reducing the issue of potential tolerances. Furthermore, the opening is easy accessible from rear and front when approaching the vehicle as well as entering the vehicle.

For example, the articulate side panel may include an inside surface arranged to follow an outside surface of the central body in facing relationship during part of opening movement. Thus, the entire central body inside is protected from rain, snow and other environmental impact during opening and in its opened condition. Furthermore, the increased area, covering the top of the vehicle from above during opening and in its open condition, works like a cover for the interior of the vehicle in some rainy and/or snowy conditions. Furthermore, the close following of the movable side panel in relation to the central body outer surface reduces the risk of e.g. interfering with traffic from the behind during opening by the side of a road or street.

Advantageously, the articulate side panel may be pivotally attached to a tap arrangement, the tap arrangement in turn being pivotally attached to the central body. This arrangement provides for a robust and reliable movement of the central body during opening and closing. By lifting the side panel using a double articulated device an increased opening degree as well as increased margins relative to the sides of the front body of the vehicle during the following pivoting movement is accomplished. The articulate side panel may be pivotally attached via a tap arrangement to a beam structure underneath a side window of said central body. The central body may include a roof portion and one side panel on each side of the roof portion, with each one side panel forming a door-like structure.

In a further example embodiment, the central body may be pivotally attached by the rear part of a front hood of the vehicle below the front window of said central body. Advantageously, the central body may be held by at least one biasing device in its closed condition in order to support opening movement. Alternatively, the opening movement of the central body is powered by an electric motor or hydraulic gear. It is desirable to achieve a smooth and comfortable opening operation of the vehicle.

Accordingly there is also, according to at least one embodiment of the invention, provided a method for opening a vehicle body structure providing a driver compartment and including an opening into the compartment, a central body cooperatively dimensioned and configured to close the opening, the opening being formed by portions of the body structure. The method includes the steps of maneuvering a side panel articulately arranged to portions of said central body by the opening along a lengthwise propagation of the vehicle body structure, and pivoting the central body relative to an axis propagating in the transverse direction of the vehicle body structure for enabling pivotal movement upwards and away from said opening during opening movement.

In an example embodiment, the central body may be pivotally attached by the rear part of a front hood of the vehicle below the front window of said central body and pivotal movement of said central body is initiated when said side panels are in their fully lifted position.

### BRIEF DESCRIPTION OF THE DRAWINGS

An example embodiment of the present invention will now be described in more detail, with reference to the accompanying drawings.

FIGS. 1a-1f present schematically in perspective view an opening sequence of a wheeled automotive vehicle provided with a door opening system according to an embodiment of the invention, wherein,

FIG. 1a discloses the vehicle door opening system in a closed condition,

FIG. 1b discloses an initial movement of the door panel,

FIG. 1c presents the continuing movement of the door panel during opening,

FIG. 1d presents the door panel in its fully open condition according to an example embodiment,

FIG. 1e discloses the further opening sequence of pivoting a central section of the vehicle during opening,

FIG. 1f discloses a vehicle according to an example embodiment in an opened condition.

### DETAILED DESCRIPTION OF THE EXAMPLE EMBODIMENTS

A first embodiment of the invention related to a wheeled automotive vehicle will be described in more detail in the following with reference to the accompanying drawings.

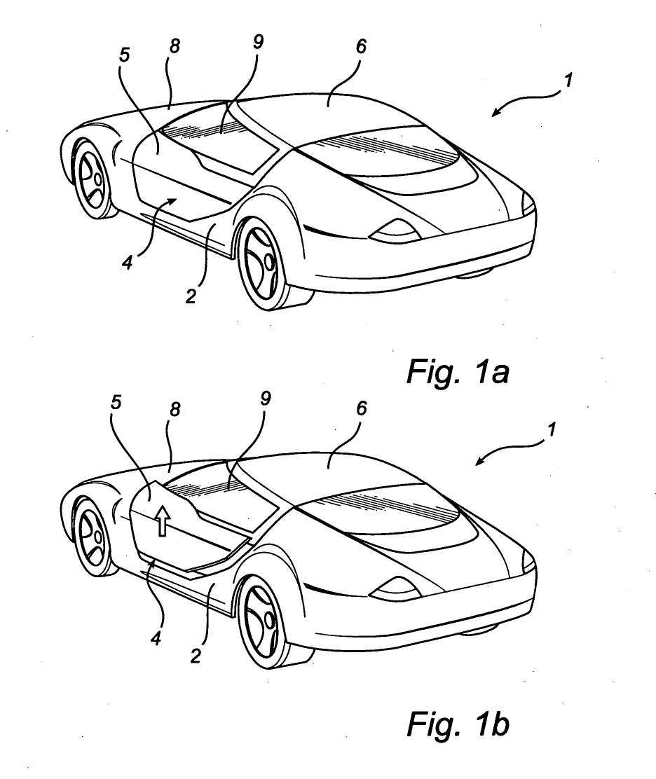

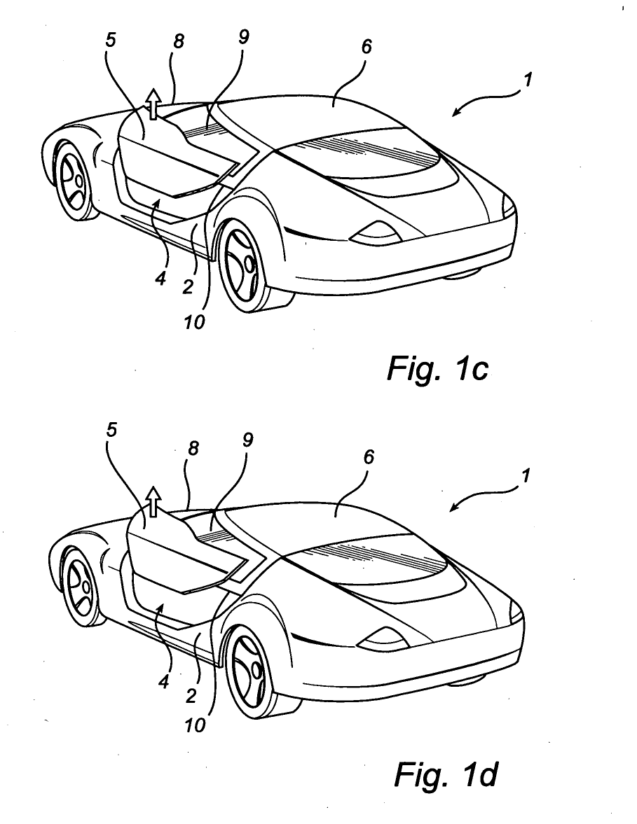

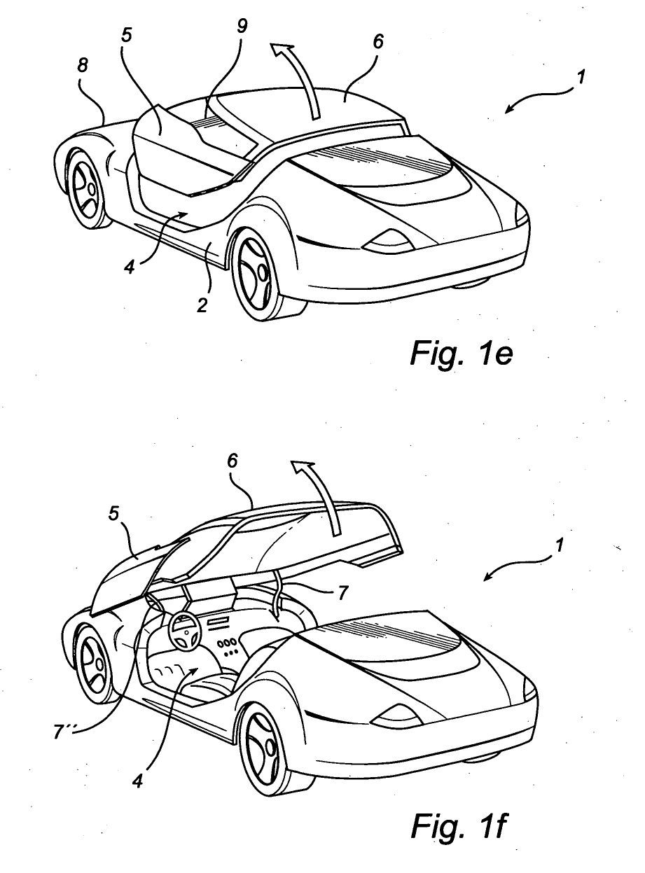

Referring now to FIG. 1a, a car 1 is disclosed with a body structure 2. The body structure 2 provides a driver compartment 3. An opening 4 into the compartment 3 is covered by a door 9 cooperatively dimensioned and configured to close the opening 4. A central body includes a roof portion 6 and one side panel 5 on each side of said roof portion 6, each one side panel 5 forming a door-like structure. The central body includes a side panel 5 articulately arranged to portions of the central body by the opening 4 along a lengthwise propagation of the vehicle body structure 2.

In FIG. 1b it is disclosed what happens in the initial stage during opening. The side panel 5 has an inside surface arranged to follow an outside surface of the central body in facing relationship during the first stage of opening movement. The articulate side panel 5 is pivotally attached to a tap arrangement, the tap arrangement in turn being pivotally attached to the central body. The articulate side panel 5 is pivotally attached via a tap arrangement to a beam structure 10 underneath a side window 9 of said central body.

Referring further to FIG. 1d where the continuing upward articulated movement of the side panel 5 is disclosed. The side panel 5 follows the tumblehome of the vehicle, thus covering the opening from above without projecting too much outside the main body.

In FIG. 1d the side panel has reached its top position and the next movement is about to follow. The front side of the side panel 5 is in a position with sufficient clearance in relation to the vehicle body and especially the side of the hub in order to avoid obstruction in the following pivoting movement. The side panel 5 is covering part of the side window 9 which is held in position by the lower beam 10.

Referring now to FIG. 1e, pivoting movement of the central body relative to an axis propagating in the transverse direction of the vehicle body structure is described. The pivoting arrangement enables pivotal movement of the central body upwards and away from the opening 4 and towards the hood during opening movement. The central body is pivotally attached by the rear part of the front hood 8 of the vehicle 1 below the front window of the central body. In order to enable a smooth and comfortable opening sequence of said central body it is held by biasing means (not shown) in its closed condition in order to support opening movement. When activating the movement, the at least one biasing device performs the whole opening sequence. Alternatively, the opening movement of the central body is powered by an electric motor or hydraulic gear.

During closing, the movement is reversed to the above described and works together with the force of gravity such that it will be easy to control. For example, the actuation of opening and closing may be performed by a command signal, e.g. from a button on a panel, a remote key or key FOB.

In FIG. 1f the vehicle according to an example embodiment is disclosed in an opened condition. Although disclosed by an example embodiment, it is submitted that the skilled person may readily adapt the vehicle such that the pivoting movement of the central body is performed about a transverse axis located at the rear body of the vehicle. In such a case the pivoting movement will result in an open position of the vehicle with the roof of the central body sloping rearwards.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wheeled automotive vehicle comprising:
a vehicle body structure including a driver compartment and including an opening into the compartment, the opening being formed by portions of the vehicle body structure; and
a central body cooperatively dimensioned and configured to close the opening, the central body including a side panel articulately arranged to portions of the central body by the opening along a lengthwise propagation of the vehicle body structure, and the central body being pivotally arranged relative to an axis propagating in the transverse direction of the vehicle body structure to enable pivotal movement upwards and away from the opening during opening movement.

2. The vehicle according to claim 1, wherein said articulate side panel includes an inside surface arranged to follow an outside surface of the central body in facing relationship during part of opening movement.

3. The vehicle according to claim 1, wherein said articulate side panel is pivotally attached to a tap arrangement, said tap arrangement in turn being pivotally attached to said central body.

4. The vehicle according to claim 1, wherein said articulate side panel is pivotally attached via a tap arrangement to a beam structure underneath a side window of said central body.

5. The vehicle according to claim 1, wherein said central body includes a roof portion and one side panel on each side of said roof portion, said each one side panel forming a door-like structure.

6. The vehicle according to claim 1, wherein said central body is pivotally attached by the rear part of a front hood of the vehicle below the front window of said central body.

7. The vehicle according to claim 1, wherein said central body is held by at least one biasing device in its closed condition in order to support opening movement.

8. The vehicle according to claim 1, wherein the opening movement of said central body is powered by at least one of an electric motor and a hydraulic gear.

9. Method for a wheeled automotive vehicle including a vehicle body structure, including a driver compartment and including an opening into the compartment, and a central body cooperatively dimensioned and configured to close the opening, the opening being formed by portions of the body structure, the method comprising:
maneuvering a side panel articulately arranged to portions of the central body by the opening along a lengthwise propagation of the vehicle body structure; and
pivoting the central body relative to an axis propagating in the transverse direction of the vehicle body structure to enable pivotal movement upwards and away from the opening during opening movement.

10. The method according to claim 9, wherein the central body is pivotally attached by the rear part of a front hood of the vehicle below the front window of said central body, and pivotal movement of said central body is initiated when said side panels are in their fully lifted position.

11. The vehicle according to claim 2, wherein said articulate side panel is pivotally attached to a tap arrangement, said tap arrangement in turn being pivotally attached to said central body.

12. The vehicle according to claim 2, wherein said articulate side panel is pivotally attached via a tap arrangement to a beam structure underneath a side window of said central body.

13. The vehicle according to claim 3, wherein said articulate side panel is pivotally attached via a tap arrangement to a beam structure underneath a side window of said central body.

14. The vehicle according to claim 2, wherein said central body includes a roof portion and one side panel on each side of said roof portion, said each one side panel forming a door-like structure.

15. The vehicle according to claim 3, wherein said central body includes a roof portion and one side panel on each side of said roof portion, said each one side panel forming a door-like structure.

16. The vehicle according to claim 4, wherein said central body includes a roof portion and one side panel on each side of said roof portion, said each one side panel forming a door-like structure.

17. The vehicle according to claim 2, wherein said central body is pivotally attached by the rear part of a front hood of the vehicle below the front window of said central body.

18. The vehicle according to claim 2, wherein said central body is held by at least one biasing device in its closed condition in order to support opening movement.

19. The vehicle according to claim 2, wherein the opening movement of said central body is powered by at least one of an electric motor and a hydraulic gear.
